(19) United States
(12) Patent Application Publication
(10) Pub. No.: US 2014/0156326 A1
(43) Pub. Date: Jun. 5, 2014

(54) SYSTEM AND METHOD FOR AUTOMATING AND IMPROVING SELF SERVICE EXPERIENCE

(71) Applicant: AVAYA INC., Basking Ridge, NJ (US)

(72) Inventors: Paul D'Arcy, Limerick (IE); Neil O'Connor, Galway (IE); Tony McCormack, Galway (IE)

(73) Assignee: AVAYA INC., Basking Ridge, NJ (US)

(21) Appl. No.: 13/690,115

(22) Filed: Nov. 30, 2012

(51) Int. Cl. G06Q 30/00

(52) U.S. Cl. CPC G06Q 30/016
USPC 705/7.14; 705/7.15; 705/304

(57) ABSTRACT

A contact center includes a plurality of work item queues or repository of pending work and a plurality of agents servicing work items from the plurality of work item queues. The contact center further includes a self service system that is operable to harvest information related to customers from a context store, tailor a self service configuration for a customer based on the harvested information, and provide a self service interaction to the customer based on the tailored self service configuration.

### BACKGROUND

1. Field of the Invention

Embodiments of the present invention generally relate to contact centers and particularly to increasing contact center efficiency.

2. Description of Related Art

Contact centers are employed by many enterprises to service inbound and outbound contacts from customers. A typical contact center includes a switch and/or server to receive and route incoming packet-switched and/or circuit-switched contacts and one or more resources, such as human agents and automated resources (e.g., Interactive Voice Response (IVR) units), to service the incoming contacts. Contact centers distribute contacts, whether inbound or outbound, for servicing to any suitable resource according to predefined criteria.

In many existing systems, the criteria for servicing the contact from the moment the contact center becomes aware of the contact until the contact is connected to an agent are client or operator-specifiable (i.e., programmable by the operator of the contact center), via a capability called vectoring. In known Automatic Call Distributors (ACDs) when the ACD system's controller detects an agent has become available to handle a contact, the controller identifies all predefined contact-handling queues for the agent (usually in some order of priority) and delivers to the agent the highest-priority, oldest contact that matches the agent's highest-priority queue. Generally, the only condition that results in a contact not being delivered to an available agent is that there are no contacts waiting to be handled.

The primary objective of contact center management is to ultimately maximize contact center performance/profitability, and contact satisfaction. An ongoing challenge in contact center administration is monitoring and optimizing contact center efficiency while keeping the contact satisfied. Contact center efficiency is generally measured in two ways.

Service level is one measurement of contact center efficiency. Service level is typically determined by dividing number of contacts accepted within the specified period by number accepted plus the number that were not accepted, but completed in some other way (e.g., abandoned, given busy, cancelled, flowed out). Of course, service level definitions may vary from one enterprise to another.

Match rate is another indicator used in measuring contact center efficiency. Match rate is usually determined by dividing the number of contacts accepted by a primary skill level agent within a period of time by the number of contacts accepted by any agent for a queue over the same period. An agent with a primary skill level is one that typically can handle contacts of a certain nature most effectively and/or efficiently. There are other contact center agents who may not be as proficient as the primary skill level agent, and those agents are identified either as secondary skill level agents or backup skill level agents. As can be appreciated, contacts received by a primary skill level agent are typically handled more quickly and accurately or effectively (e.g., higher revenue attained) than a contact received by a secondary or even backup skill level agent. Thus, it is an objective of most contact centers to optimize match rate along with service level.

In addition to service level and match rate performance measures, contact centers use other Key Performance Indicators (“KPIs”), such as revenue, estimated, actual, or predicted wait time, average speed of answer, throughput, agent utilization, agent performance, agent responsiveness, and the like, to calculate performance relative to their Service Level Agreements (“SLAs”). Operational efficiency is achieved when KPIs are managed near, but not above, SLA levels.

Throughput is a measure of the number of calls/contact requests or work requests that can be processed in a given amount of time. Agent utilization is a measure of how efficiently agents' time is being used. Customer service level is a measure of the time customers spend waiting for their work to be handled. Company contact center customers wish to provide service to as many requests as possible in a given amount of time, using the least number of agents to do so, and minimizing the wait time for their customers.

Typically, when a new work request arrives into a contact center, an agent to work on it is selected according to the goals of the contact center. If the goal is to increase throughput and agent utilization and reduce response time on work requests, then one factor affecting this goal is presentation of a suitable self service configuration of IVR for each customer. Each customer may have different queries and may require a different self service menu to quickly resolve his query. Sometimes, menus of the self service IVR are quite frustrating for a caller, and he ends the call in frustration without getting desired information.

Further, if the customer wishes to speak to a customer service representative or an agent from the contact center for any help, then the caller is not able to understand the agent language due to different accent. Further, even if the caller again tries to contact the contact center, he gets the same menus and a similar helping agent leaving him further frustrated. Also, agents are also under-utilized in this arrangement. Hence, for proper utilization of the contact center, suitable menus are desired for a caller. Further, for proper utilization of agents, optimal selection of suitable agents is required.

Traditional contact centers, ACDs and workflow routers typically rely on a manual process, for example, input is requested from customer based upon pre-determined interactive voice prompts. However, the traditional contact centers do not attempt to improve the self service configuration of customers to improve future self service experience of the customers. More particularly, traditional contact centers do not efficiently leverage the vast amount of data from previous and current communication channels.

Further, automated modification of the future customer self service interaction experience is rather limited in the traditional contact centers. More specifically, traditional contact centers lack capability to effectively utilize the vast amount of data from the previous and current communication channels.

There is thus a need for a contact center that can leverage past information to modify self service interactions between a caller or contact and an enterprise, avoid unnecessary sub menus, and optimally select agents to route work requests accordingly.

### SUMMARY

Embodiments in accordance with the present invention provide a self service system for a contact center. The self service system includes a harvest module configured to harvest information related to customers. The self service system further includes a tailor module configured to automatically tailor a self service configuration for a customer, based on the harvested information. The self service system furthermore includes a service module configured to provide a self service interaction to the customer, based on the tailored self service configuration.

Embodiments in accordance with the present invention further provide a method for automating self service experience for a customer in a contact center. The method includes harvesting information related to customers, tailoring a self service configuration for a customer based on the harvested information, and providing a customized self service interaction to the customer with the contact center based on the tailored self service configuration.

Embodiments in accordance with the present invention further provide a contact center including a plurality of work item queues or repository of pending work and a plurality of agents servicing work items from the plurality of work item queues or repository of pending work. The contact center further includes a self service system operable to harvest information related to customers from a context store, tailor a self service configuration for a customer based on the harvested information, and provide a self service interaction to the customer based on the tailored self service configuration.

The present invention can provide a number of advantages depending on a particular configuration. First, the present invention provides consistent reliable automation of the assessment of the customer disposition, and uses this information to tailor future customer interactions.

The present invention also provides an improved self-service system that provides a better matching agent for a contact, based on previous interactions of that contact or caller with the contact center. Further, the present invention improves and tailors self service interactions between a customer and an enterprise based on previous interactions of the customer with agents of a contact center.

In one embodiment of the present invention, the customer may be provided a better matching agent matching to language and accent of the customer. Furthermore, an embodiment of the present invention may shorten an IVR tree for a customer to suit his requirement thereby saving time of the customer. Furthermore, an embodiment of the present invention may invite supervisor into interaction of the customer and the agent. Next, an embodiment of the present invention may play different tailored prompts to suit needs of the customer based on his previous interaction. Further, embodiments of the present invention provide intelligent process workflow awareness prompts to decrease service time of a customer in a self service. Furthermore, embodiments of the present invention provide a customized self service experience for each customer according to their individual requirement, rather than a universal and common self service experience for everyone.

Further, embodiments of the present invention replace a statically provisioned automated customer contact interaction systems with a dynamic automated customer contact interactions system based on large data driven of previous interactions.

These and other advantages will be apparent from the disclosure of the present invention(s) contained herein.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read.

A digital file attachment to e-mail or other self-contained information archive or set of archives is considered a distribution medium equivalent to a tangible storage medium. When the computer-readable media is configured as a database, it is to be understood the database may be any type of database, such as relational, hierarchical, object-oriented, and/or the like. Accordingly, embodiments of the present invention are considered to include a tangible storage medium or distribution medium and prior art-recognized equivalents and successor media, in which the software implementations of the present invention are stored.

The terms “determine”, “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the present invention is described in terms of exemplary embodiments, it should be appreciated those individual aspects of the present invention can be separately claimed.

The term “switch” or “server” as used herein should be understood to include a PBX, an ACD, an enterprise switch, or other type of communications system switch or server, as well as other types of processor-based communication control devices such as media servers, computers, adjuncts, etc.

The preceding is a simplified summary of the present invention to provide an understanding of some aspects of the present invention. This summary is neither an extensive nor exhaustive overview of the present invention and its various embodiments. It is intended neither to identify key or critical elements of the present invention nor to delineate the scope of the present invention but to present selected concepts of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of the present invention will become apparent upon consideration of the following detailed description of embodiments thereof, especially when taken in conjunction with the accompanying drawings wherein like reference numerals in the various figures are utilized to designate like components, and wherein:

FIG. 1 is a block diagram depicting a contact center according to an embodiment of the present invention;

FIG. 2 is a block diagram of a server according to an embodiment of the present invention; and

FIG. 3 is a flowchart depicting an embodiment of the present invention.

The headings used herein are for organizational purposes only and are not meant to be used to limit the scope of the description or the claims. As used throughout this application, the word ^{may} is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

The present invention will be illustrated below in conjunction with an exemplary communication system. Although well suited for use with, e.g., a system having an ACD or other similar contact processing switch, the present invention is not limited to any particular type of communication system switch or configuration of system elements. Those skilled in the art will recognize that the disclosed techniques may be used in any communication application in which it is desirable to provide improved contact processing.

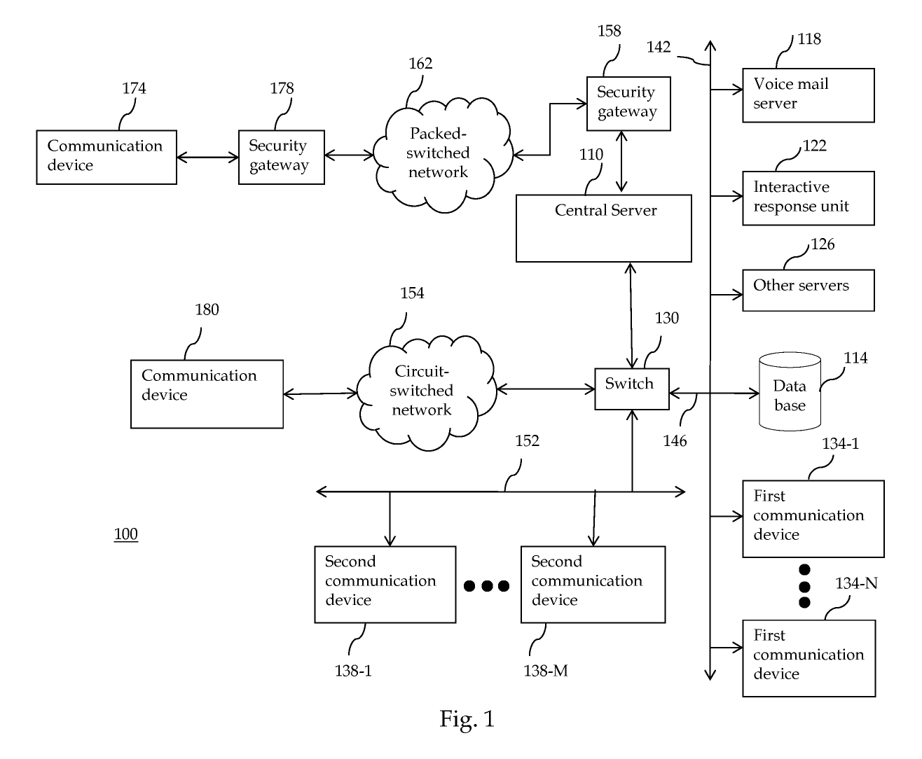

FIG. 1 shows an illustrative embodiment of the present invention. A contact center 100 comprises a central server 110, a set of data stores or databases 114 containing contact or customer related information and other information that can enhance the value and efficiency of the contact processing, and a plurality of servers, namely a voice mail server 118, an Interactive Response unit (e.g., IVR) 122, and other servers 126, a switch 130, a plurality of working agents operating packet-switched (first) communication devices 134-1 to N (such as computer work stations or personal computers), and/or circuit-switched (second) communication devices 138-1 to M, all interconnected by a local area network LAN (or wide area network WAN) 142. The servers can be connected via optional communication lines 146 to the switch 130.

As will be appreciated, the other servers 126 can also include a scanner (which is normally not connected to the switch 130 or Web server), VoIP software, video call software, voice messaging software, an IP voice server, a fax server, a web server, an email server, and the like. The switch 130 is connected via a plurality of trunks 150 to the Public Switch Telephone Network or PSTN 154 and via link(s) 152 to the second communication devices 138-1 to M. A gateway 158 is positioned between the server 110 and the packet-switched network 162 to process communications passing between the server 110 and the network 162.

Although this embodiment of the present invention is discussed with reference to a client-server architecture, it is to be understood the principles of the present invention apply to other network architectures. For example, the present invention applies to peer-to-peer networks, such as those envisioned by the Session Initiation Protocol. In the client-server model or paradigm, network services and the programs used by end users to access the services are described. The client side provides a user with an interface for requesting services from the network, and the server side is responsible for accepting user requests for services and providing the services transparent to the user.

By contrast in the peer-to-peer model or paradigm, each networked host runs both the client and server parts of an application program. Additionally, the present invention does not require the presence of packet- or circuit-switched networks.

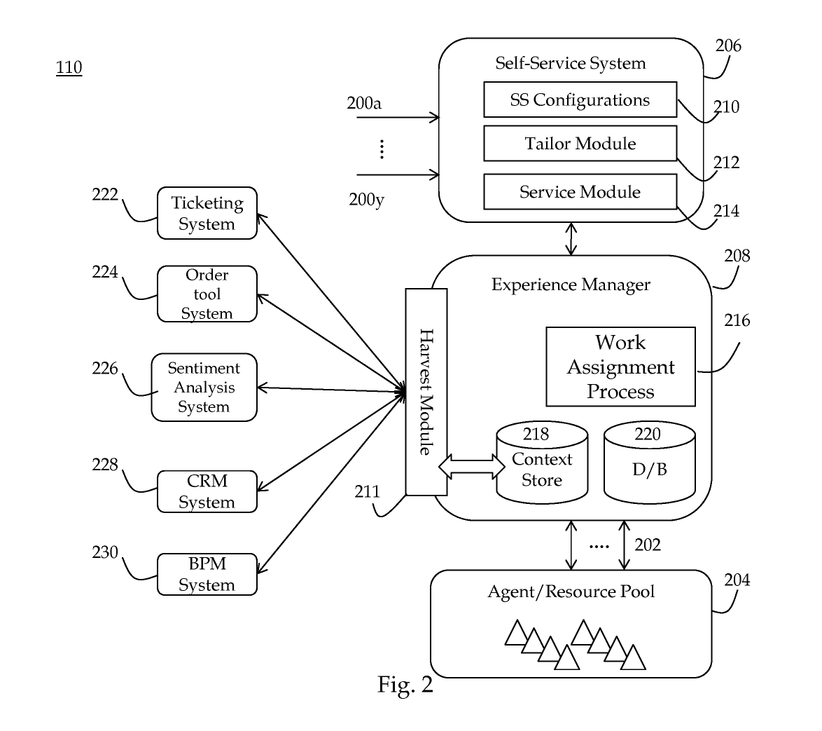

Referring to FIG. 2, one possible configuration of the server 110 is depicted. The server 110 is in communication with a plurality of customer communication lines 200a-y (which can be one or more trunks, phone lines, etc.) and agent communication line 202 (which can be a voice-and-data transmission line such as LAN 142 and/or a circuit switched voice line). The server 110 can include an operational contact center reporting module (not shown), such as Avaya IQ™, CMS™, Basic Call Management System™, Operational Analyst™, and Customer Call Routing or CCR™ by Avaya, Inc., which gathers call records and contact-center statistics for use in generating contact-center reports.

The switch 130 and/or server 110 can be any architecture for directing contacts to one or more communication devices. In some embodiments of the present invention, the switch 130 may perform load-balancing functions by allocating incoming or outgoing contacts among a plurality of logically and/or geographically distinct contact centers. Illustratively, the switch and/or server can be a modified form of the subscriber-premises equipment sold by Avaya Inc. under the names Definity™ Private-Branch Exchange (PBX)-based ACD system, MultiVantage™ PBX, Communication Manager™, S8300™ media server and any other media servers, SIP Enabled Services™, Intelligent Presence Server™, and/or Avaya Interaction Center™, and any other products or solutions offered by Avaya or another company.

Typically, the switch/server is a stored-program-controlled system that conventionally includes interfaces to external communication links, a communications switching fabric, service circuits (e.g., tone generators, announcement circuits, etc.), memory for storing control programs and data, and a processor (i.e., a computer) for executing the stored control programs to control the interfaces and the fabric and to provide automatic contact-distribution functionality. Other types of known switches and servers are well known in the art and therefore not described in detail herein.

As can be seen in FIG. 2, included among the data stored in the server 110 is a separate set of agent queues 204. Each agent's queues are prioritized according to his or her level of expertise or skill in that queue, and either agents are queued in individual ones of agent queues 204 in their order of expertise level or are queued in different ones of a plurality of agent queues that correspond to a queue and each one of which corresponds to a different expertise level.

Included among the control programs in the server 110 is a work assignment process 216. Contacts incoming to the contact center are assigned by the work assignment process 216 to different contact queues based upon a number of predetermined criteria, including customer identity, customer needs, contact center needs, current contact center queue lengths, customer value, and the agent skill that is required for the proper handling of the contact.

Agents who are available for handling contacts are assigned to agent queues 204a-n based upon the skills that they possess. An agent may have multiple skills, and hence may be assigned to multiple agent queues simultaneously. Furthermore, an agent may have different levels of skill expertise (e.g., skill levels 1-N in one configuration or merely primary skill levels and secondary skill levels in another configuration), and hence may be assigned to different agent queues at different expertise levels.

In one configuration, the contact center is operated by a contract operator, and each of the contact queues, and possibly each of the agent queues, corresponds to a different client. Each client can have a separate service level agreement or other type of performance measurement agreement with the contract operator regarding performance expectations, goals, requirements or specifications for the client's respective queue(s).

Referring again to FIG. 1, the gateway 158 can be Avaya Inc.'s, G700 Media Gateway™ and may be implemented as hardware such as via an adjunct processor (as shown) or as a chip in the server.

The first communication devices 134-1, . . . 134-N are packet-switched and can include, for example, IP hardphones such as the Avaya Inc.'s, 4600 Series IP Phones™, IP softphones such as Avaya Inc.'s, IP Softphone™, Personal Digital Assistants or PDAs, Personal Computers or PCs, laptops, packet-based H.320 video phones and conferencing units, packet-based voice messaging and response units, packet-based traditional computer telephony adjuncts, peer-to-peer based communication devices, and any other communication device.

The second communication devices 138-1, . . . 138-M are circuit-switched. Each of the communication devices 138-1, . . . 138-M corresponds to one of a set of internal extensions Ext1, . . . ExtM, respectively. The second communication devices can include, for example, wired and wireless telephones, PDAs, H.320 videophones and conferencing units, voice messaging and response units, traditional computer telephony adjuncts, and any other communication device.

It should be noted that the present invention does not require any particular type of information transport medium between switch or server and first and second communication devices, i.e., the present invention may be implemented with any desired type of transport medium as well as combinations of different types of transport channels.

The packet-switched network 162 can be any data and/or distributed processing network, such as the Internet. The network 162 typically includes proxies (not shown), registrars (not shown), and routers (not shown) for managing packet flows.

The packet-switched network 162 is in communication with a first communication device 174 via a gateway 178, and the circuit-switched network 154 with an external second communication device 180.

In a preferred configuration, the server 110, network 162, and first communication devices 134 are Session Initiation Protocol or SIP compatible and can include interfaces for various other protocols such as the Lightweight Directory Access Protocol or LDAP, H.248, H.323, Simple Mail Transfer Protocol or SMTP, IMAP4, ISDN, E1/T1, and analog line or trunk.

It should be emphasized that the configuration of the switch, server, user communication devices, and other elements as shown in FIG. 1 is for purposes of illustration only and should not be construed as limiting the present invention to any particular arrangement of elements.

According to an embodiment of the present invention, a harvest module 211, a tailor module 212, and a service module 214 are provided. The modules are stored either in the main memory or in a peripheral memory (e.g., disk, CD ROM, etc.) or some other computer-readable medium of the center 100.

The modules 211, 212 and 214 monitor the occupants of the work item and agent queues, respectively, and contact center objectives, rules, and policies, self service menus, configurations and assigns agents to service work items. As will be appreciated, the central server 110 is notified via LAN 142 of an incoming contact by a communications component (e.g., switch 130, fax server, email server, web server, and/or other server) receiving an incoming contact. The incoming contact is held by the receiving communications component until the modules forward instructions to the receiving communications component to forward or route the contact to a specific contact center resource, such as the interactive response unit 122, the voice mail server 118, and/or first or second communication device 134, 138 associated with a selected agent. The service module 214 provides self service interaction to the contacts, distributes and connects these contacts to communication devices of available agents based on the predetermined criteria noted above.

The harvest module 211 is configured to build or add data (or relevant information for customers) to a context store 218 stored in experience manager 208. The context store 218 is a database or repository that stores various transit data, for example, data related to customer interaction. An additional database 220 may be utilized by the harvest module 218 to process data, and to store other data. A contact or customer may communicate with disparate systems.

In an embodiment of the present invention, the harvest module 214 may communicate with a ticketing system 222, an order tool system 224, a sentiment analysis engine 226, a customer relationship management (CRM) system 228, and a business process management system (BPM) 230 to build or add data to the context store 218, as shown in FIG. 2. The harvest module 211 may communicate with these systems and provide updated data to the context store 218.

In an example, following a customer interaction with an agent of the contact center, the harvest module 218 may update the context store 218. In another embodiment of the present invention, the ticketing system 222, the order tool system 224, the sentiment analysis data 226, the customer relationship management (CRM) system 228, and the business process management system (BPM) 230 may directly push information, as well as, extract it out of the context store.

In an embodiment of the present invention, the sentiment analysis data may include sentiment of a contact, for example, happy, angry, complain, etc. during an interaction of the contact with a contact center agent.

The CRM updates may include data about any update in customer or contact relation with the enterprise or the contact center. The order update information may include update about the total order placed by the contact. The call/interaction metrics may include call duration, number of participants, was call transferred, was supervisor involved, etc. Further, any component or system of the contact center, for example, a self service system 206, can access the context store 218, retrieve the context information, update it, change it, put it back in again, and so on and so forth.

The harvest module 211 may harvest relevant data from disparate sources related to customers. For example, the harvest module 211 may harvest relevant data related to the customers from the context store 218. In an embodiment of the present invention, the harvest module 211 harvests the sentiment analysis data, the CRM updates, the order update information, Post call/interaction survey, Call/interaction metrics, and any interaction context data, as described above. The harvest module 211 gathers above data and other information that has changed during, and in the aftermath of, the customer interaction.

The context store 218 may further store any information, for example, information related to interaction, information related to context of interaction, current information, or case information, and updates information. For example, once an agent finish the call, the harvest module 211 can start processing and storing the information in the context store 218.

In an embodiment of the present invention, as contacts (or customers) and agents interact, each sentence/speech may be saved and a speech voice stream may be built. Over time, as a contact interacts time and again with agents of the contact center, similar patterns/traits may be identified related to the contact. In an embodiment of the present invention, the patterns and relevant information related to a customer may be tagged with the same customer. The patterns related to the contact may be used as future input to future automated interactions between the contact and the agents.

Next, the tailor module 212 may tailor a self service configuration 210 stored in the self service system 206 for a customer based on the harvest information by the harvest module 211. The self service configuration 210 may store particular settings related to a particular contact, options selected or preferred by the contact during self service interaction with the contact center, and other customized information for example, better matching agent, or agent who solved his query last time.

Based on the harvested information, the tailor module 212 may calculate useful changes to self service configuration 210 in order to tailor future customer interactions. For example, if a particular customer only enquires about a certain information during self service interaction with the contact center, then the customer may be provided that particular option directly without providing the full self service menu. The tailor module 212 may further tag or associate the changed self service configuration with corresponding contact or identity of the contact.

According to an embodiment of the present invention, the tailor module 212 may tailor a self service configuration for a customer for a better matching agent according to language and accent of the customer. Further, the tailor module 212 may adjust voice detection according to voice of the customer (for example, a Spanish speaking person). Furthermore, the tailor module 212 may shorten an IVR tree. In an embodiment of the present invention, the tailor module 212 may also invite supervisor into the interaction. Further, the tailor module 212 may play different tailored prompts and intelligent process workflow awareness prompts.

Next, the service module 214 may provide a self service interaction to a customer based on the tailored self service configuration 210 of the customer. The service module 214 may ask a contact to submit his identity information. The service module may match the identity information of the contact with stored identities in the database and authenticates the contact for further communication if the identity of the contact matches with an identity stored in the database.

Further, the service module 214 may retrieve a self service configuration tagged to the identity of the contact and provide corresponding self service experience. For example, if the contact or customer again approaches the contact center in future, updated self service configuration 210 may be provided to the contact. In an embodiment of the present invention, the service module 214 may also present a customized self service interaction to a customer, who has approached the contact center for the first time. The service module 214 may utilize tailored self service configuration of other customers, whose profile/traits match with profile/traits of the first time visitor.

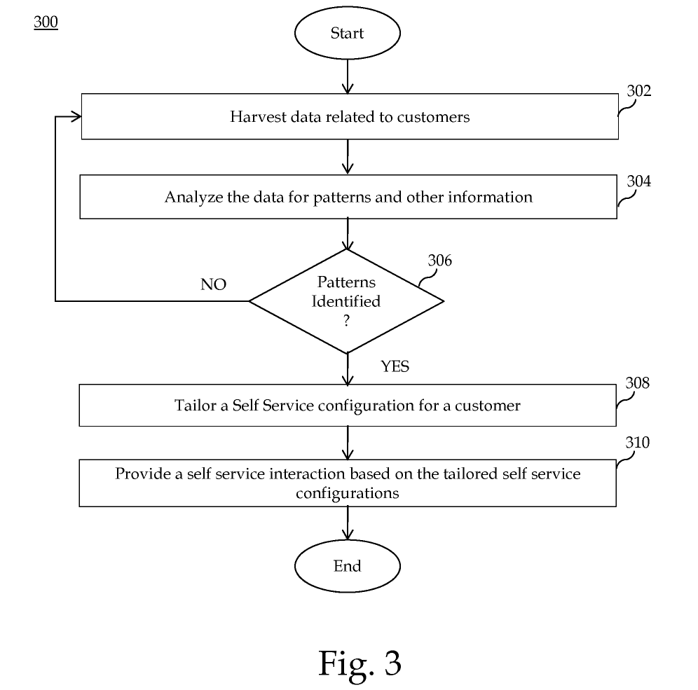

FIG. 3 illustrates a method 300 for automating and improving a self service experience in a contact center in accordance with an embodiment of the present invention.

In step 302, relevant data from disparate sources related to customers is harvested. In an embodiment of the present invention, the relevant data includes sentiment analysis data points, CRM updates, order update information, Post call/interaction survey, Call/interaction metrics (call duration, no. participants, was call transferred, was supervisor involved etc), and any interaction context data. In an embodiment of the present invention, the relevant data may be harvested by the harvest module 211.

In step 304, harvested data is analyzed for patterns and other information. Further, the harvest data may be compared with the self service configuration data to compute changes and updates in the self service configuration. In an embodiment of the present invention, the relevant data may be analyzed and the changes computed by the tailor module 212.

In step 306, it is determined whether patterns have been detected or identified. If some patterns have been identified, the patterns may be associated or tagged with that contact/customer and then the method 300 proceeds to step 308. Otherwise, the method 300 returns to 302. In an embodiment of the present invention, the relevant data may be analyzed and the changes computed by the tailor module 212.

In step 308, a self service configuration for a customer is tailored. In an embodiment of the present invention, self-service menu driven questions or responses or trees may be tweaked, to make them more refined, or more tailored to the next set of contacts/callers/customers coming. According to an embodiment of the present invention, self service prompts may be tailored to the accent of the contact, so the contact and agent can readily understand each other. Further, if a contact enquired about something new, a bespoke option about that particular enquiry may be added to the self service menu, so if the contact requires again such information, he may immediately and directly utilize the newly added option to his IVR menu, rather than going to an agent.

Further, if the contact spoke with any agent in his earlier call, and faced language issues in that call, then an agent with matching language may be automatically provided to him. Furthermore, if some particular agent resolved his query last time, then the self service configuration file may be updated with that particular agent as higher priority match for the contact. In an embodiment of the present invention, the relevant data may be harvested by the tailor module 212.

In step 310, a self service interaction is provided to a customer based on the tailored self service configuration of the customer. According to an embodiment of the present invention, revised or customized self service configurations that suit to the needs or requirement of the contact may be executed to provide an improved self service experience to the contact. The customer or contact may also be asked to provide his identity before providing tailored self service configurations. In an embodiment of the present invention, the relevant data may be harvested by the service module 214.

Examples will now be discussed to illustrate the above principles.

Following are example illustrating working of the present invention in accordance with an embodiment of the present invention. A person of ordinary skilled in the art will appreciate the present invention may be performed within any enterprise that is seeking to improve the experience of customers in future interactions, including contact centers, and more particularly self service systems in contact centers.

### EXAMPLE 1

Mr. G calls a vendor (for example, a contact center) to complain about a recently purchased laptop. Following the call, the harvest module provided by the present invention harvests the following information within the enterprise related to this interaction:

(1) Sentiment analysis: negative, also first time for negative sentiment detected on any previous call for this customer.

(2) Supervisor needed to become involved.

(3) Call received multiple transfers, and 6 minutes of inter-transfer MoH.

(4) An order cancellation is found on the CRM system.

(5) Agent repeatedly asked Mr. G to repeat sentences, indicating accent/language mismatch, etc.

(6) The cancellation was reversed during the conversation with the 3^{rd} employee, and instead a placement product was requested.

(7) Customer has a small business, has ordered 20 laptops in last 18 months including printer, other peripherals, etc.

The present invention evaluates this harvested data and these associated outcomes and re-provisions the self service application appropriately to make following changes:

(1) Self service prompts are tailored to his accent.

(2) A bespoke SS option to inquire about the replacement laptop is temporarily added until the consignment is delivered.

(3) If he elects to speak to an agent, then an agent with matching language is selected.

(4) The agent who resolved the issue becomes a higher priority match for this customer.

### EXAMPLE 2

A customer rings to a TV provider. But, the customer makes a mistake in selection of right submenu in the IVR, and hangs up immediately. The TV provider makes a note of this fact. If the same customer rings in the second time, that the self-service application of the TV provider has information and knowledge of previous call of the customer. Hence, the TV provider tailors the self service configuration of the customer so the customer does not face the same full menu of the self service IVR. Instead, the TV provides a shorten tree of the IVR for the customer, so the customer do not make same mistake again and can get his desired information easily.

The exemplary systems and methods of this present invention have been described in relation to a contact center. However, to avoid unnecessarily obscuring the present invention, the preceding description omits a number of known structures and devices. This omission is not to be construed as a limitation of the scope of the claimed invention. Specific details are set forth to provide an understanding of the present invention. It should however be appreciated that the present invention may be practiced in a variety of ways beyond the specific detail set forth herein.

Furthermore, while the exemplary embodiments of the present invention illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a switch, server, and/or adjunct, or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is/are capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the present invention.

A number of variations and modifications of the present invention can be used. It would be possible to provide for some features of the present invention without providing others.

For example in one alternative embodiment, the systems and methods of this present invention can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like.

In general, any device(s) or means capable of implementing the methodology illustrated herein can be used to implement the various aspects of this present invention. Exemplary hardware that can be used for the present invention includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment of the present invention, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this present invention is dependent on the speed and/or efficiency requirements of the system, the particular function, and the particular software or hardware systems or microprocessor or microcomputer systems being utilized.

In yet another embodiment of the present invention, the disclosed methods may be partially implemented in software that can be stored on a storage medium, executed on programmed general-purpose computer with the cooperation of a controller and memory, a special purpose computer, a microprocessor, or the like.

In these instances, the systems and methods of this present invention can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present invention describes components and functions implemented in the embodiments with reference to particular standards and protocols, the present invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the present invention has been presented for purposes of illustration and description. The foregoing is not intended to limit the present invention to the form or forms disclosed herein. In the foregoing Detailed Description for example, various features of the present invention are grouped together in one or more embodiments, configurations, or aspects for the purpose of streamlining the disclosure. The features of the embodiments, configurations, or aspects of the present invention may be combined in alternate embodiments, configurations, or aspects other than those discussed above.

This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A self service system in a contact center, comprising:
a harvest module configured to harvest information related to customers;
a tailor module configured to automatically tailor a self service configuration for a customer, based on the harvested information; and
a service module configured to provide a self service interaction to the customer, based on the tailored self service configuration.

2. The self service system of claim 1, wherein the harvest module harvests information related to customers from a context store.

3. The self service system of claim 1, wherein the harvest module identifies patterns based on previous communication of the customer with the contact center.

4. The self service system of claim 1, wherein the harvest module harvests information about sentiment analysis following a customer interaction with the contact center.

5. The self service system of claim 1, wherein the tailor module is configured to tailor the self service configuration of the customer for an agent matching to a language and accent of the customer.

6. The self service system of claim 1, wherein the tailor module is configured to tailor a higher priority match for the customer based on the previous resolved query.

7. The self service system of claim 1, wherein the tailor module is further configured to add a customized option in self service menu of the customer matching to last enquiry made by the customer.

8. The self service system of claim 1, wherein the tailor module is further configured to shorten IVR tree for a customer to match requirement of the customer.

9. A computer-implemented method for automating self service experience for a customer in a contact center, the method comprising:
harvesting information related to customers;
tailoring a self service configuration for a customer based on the harvested information; and
providing a customized self service interaction to the customer with the contact center based on the tailored self service configuration.

10. The computer-implemented method of claim 9, wherein the harvesting comprises harvesting information related to customers from a context store.

11. The computer-implemented method of claim 9, wherein the harvesting further comprises identifying patterns in communication of the customer with the contact center.

12. The computer-implemented method of claim 9, wherein the harvesting comprises harvesting information about sentiment analysis following a customer interaction with the contact center.

13. The computer-implemented method of claim 9, wherein the tailoring comprises tailoring the self service configuration of the customer for an agent matching to a language and accent of the customer.

14. The computer-implemented method of claim 9, wherein the tailoring comprises tailoring a higher priority match for the customer based on the previous resolved query.

15. A contact center, comprising:
a plurality of work item queues or repository of pending work;
a plurality of agents servicing work items from the plurality of work item queues or repository of pending work; and
a self service system operable to:
harvest information related to customers from a context store;
tailor a self service configuration for a customer based on the harvested information; and
provide a self service interaction to the customer based on the tailored self service configuration.

16. The contact center of claim 15, wherein the plurality of work item queues or repository of pending work comprises self service requests.

17. The contact center of claim 15, wherein the self service system is operable to harvest information related to customers from a context store.

18. The contact center of claim 15, wherein the self service system s further operable to shorten IVR tree for a customer to match requirement of the customer.

19. The contact center of claim 15, wherein the self service system is further operable to tailor a higher priority match for the customer based on the previous resolved query.

20. The contact center of claim 15, wherein the self service system is further operable to add a customized option in self service menu of the customer matching to last enquiry made by the customer.
